(19) United States
(12) Patent Application Publication
(10) Pub. No.: US 2021/0274055 A1
(43) Pub. Date: Sep. 2, 2021

(54) CONNECTION PREVENTING MEMBER AND IMAGE FORMING APPARATUS

(71) Applicant: Reo KOJIMA, Kanagawa (JP)

(72) Inventor: Reo KOJIMA, Kanagawa (JP)

(73) Assignee: Ricoh Company, Ltd., Tokyo (JP)

(21) Appl. No.: 17/175,861

(22) Filed: Feb. 15, 2021

(30) Foreign Application Priority Data
Feb. 28, 2020 (JP) 2020-033615

(51) Int. Cl. H04N 1/00; H04N 1/21; H01R 13/436

(52) U.S. Cl. CPC H04N 1/00557; H04N 1/2158; H01R 13/4362; H01R 2201/06; H04N 2201/0063; H04N 2201/0049; H04N 1/00326

(57) ABSTRACT

A connection preventing member includes an insertion portion and a handle. The insertion portion is configured to mechanically engage with a connector housing having an opening connected to an input and output (I/O) port of an electric apparatus. The insertion portion includes a lock unit configured to engage with an engagement portion of the connector housing. The handle is connected to the insertion portion via a connecting portion. The handle is configured to be foldable at the connecting portion and separable from the insertion portion after the insertion portion is inserted into the connector housing. The lock unit is at a position at which the insertion portion covers a terminal portion of the connector housing when the lock unit engages with the engagement portion and the handle is separated from the insertion portion.

### CROSS-REFERENCE TO RELATED APPLICATION

This patent application is based on and claims priority pursuant to 35 U.S.C. § 119(a) to Japanese Patent Application No. 2020-033615, filed on Feb. 28, 2020, in the Japan Patent Office, the entire disclosure of which is hereby incorporated by reference herein.

### BACKGROUND

### Technical Field

Embodiments of the present disclosure generally relate to a connection preventing member and an image forming apparatus.

### Description of the Related Art

Platform commonization of copiers is progressing. However, various modifications are required in response to requests from customers. As one of such requests, there is a demand for preventing a user from accessing an external terminal such as a Universal Serial Bus (USB) terminal for security and prevention of mischief.

There is known a method of filling an input and output (I/O) port of an electronic apparatus, typified by a USB port or the like, with stuff so that nothing can be physically inserted into the input and output port.

For example, there is known a technology of filling a USB connector with stuff so that another USB terminal cannot be inserted into the USB connector for the purpose of taking measures against unauthorized access to a USB port.

### SUMMARY

In an aspect of the present disclosure, a connection preventing member includes an insertion portion and a handle. The insertion portion is configured to mechanically engage with a connector housing having an opening connected to an input and output (I/O) port of an electric apparatus. The insertion portion includes a lock unit configured to engage with an engagement portion of the connector housing. The handle is connected to the insertion portion via a connecting portion. The handle is configured to be foldable at the connecting portion and separable from the insertion portion after the insertion portion is inserted into the connector housing. The lock unit is at a position at which the insertion portion covers a terminal portion of the connector housing when the lock unit engages with the engagement portion and the handle is separated from the insertion portion.

In another aspect of the present disclosure, an image forming apparatus includes a connector housing and an insertion portion of a connection preventing member. The insertion portion is inserted into the connector housing.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A, 1B, and 1C are diagrams each illustrating a configuration of a connection preventing member according to an embodiment of the present disclosure;

FIG. 2 is a diagram of a lock unit for USB (Type-A), according to an embodiment of the present disclosure;

FIGS. 3A, 3B, and 3C are schematic diagrams each illustrating a procedure for attaching a connection preventing member to an electronic device including a connector housing, according to an embodiment of the present disclosure;

FIGS. 4A and 4B are diagrams of an insertion portion and a handle before the insertion portion inserted into a connector housing and the handle are separated from each other according to an embodiment of the present disclosure;

FIGS. 5A, 5B, and 5C are diagrams each illustrating an insertion portion inserted into a connector housing from which a handle has been separated, according to an embodiment of the present disclosure;

FIG. 6 is a schematic diagram illustrating the relative positions of an insertion portion and connecting portions, according to an embodiment of the present disclosure;

FIGS. 7A and 7B are diagrams each illustrating a gap provided between a pair of connecting portions, according to an embodiment of the present disclosure; and

FIG. 8 is a diagram illustrating an external appearance of an image forming apparatus according to an embodiment of the present disclosure.

The accompanying drawings are intended to depict embodiments of the present disclosure and should not be interpreted to limit the scope thereof.

The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

Hereinafter, embodiments of the present disclosure will be described with reference to the drawings. Embodiments of the present disclosure are not limited to embodiments hereinafter described, and changes such as other embodiments, additions, modifications, and deletions may be made within the scope conceivable by those skilled in the art. Any aspects are included in the scope of the present disclosure as long as the actions and effects of the present disclosure are exhibited. Further, in the drawings, the same reference numerals are given to same components and corresponding parts having the same configurations or functions, and redundant description thereof will be omitted.

Embodiments according to the present disclosure are described below. A connection preventing member according to the present disclosure is used to prevent unauthorized computer access to connectors.

A handle is provided to prevent erroneous insertion of a small connector insertion portion of the connection preventing member. The handle is folded at positions of connecting portions of the connection preventing member after the connection preventing member is inserted into a connector housing. Thus, the connector insertion portion cannot be intentionally taken out from the connector housing.

The embodiments of the present disclosure are described below in detail with reference to the drawings.

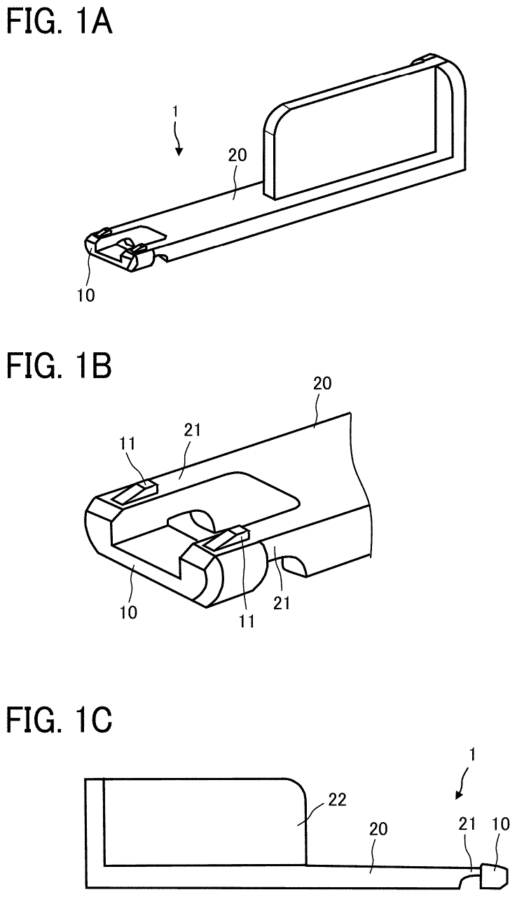

FIGS. 1A, 1B, and 1C are diagrams each illustrating a configuration of a connection preventing member 1 according to an embodiment of the present disclosure. FIG. 1A is an external perspective view of the connection preventing member 1 according to the present embodiment, FIG. 1B is a schematic perspective view of the connection preventing member 1 according to the present embodiment, and FIG. 1C is a left side view of the connection preventing member 1 according to the present embodiment.

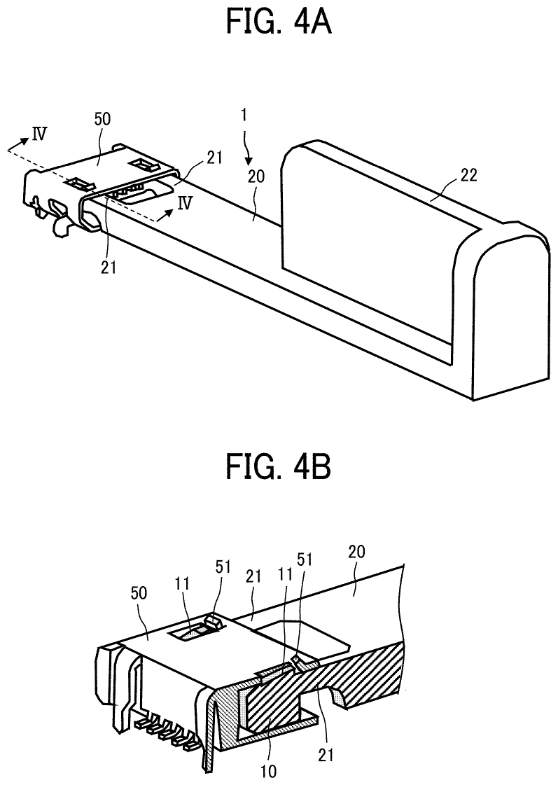

The connection preventing member 1 is inserted into an opening of a connector housing 50 (see, for example, FIG. 4B) to restrict access or connection to an input and output (I/O) port of an electronic apparatus.

The connection preventing member 1 includes an insertion portion 10 and a handle 20.

The insertion portion 10 mechanically engages with the connector housing. The insertion portion 10 includes a plurality of lock units 11 that engage with a plurality of engagement portions 51 (see, for example, FIG. 4B) provided in the connector housing 50.

The lock units 11 are formed so as to fit to the shape of the connector housing 50 into which the lock units 11 are inserted.

In FIG. 1B, protrusions or claws that serve as the lock units 11 for micro USB (Type-B), are arranged on the insertion portion 10.

In a case in which the lock units 11 are adapted for the micro USB, a plate spring or the like may be used to form the claws.

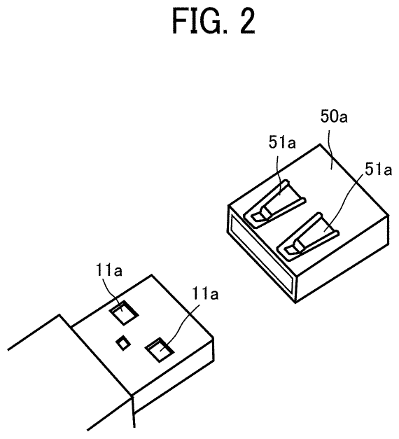

The shape of the lock units 11 is changed depending on the type of USB. FIG. 2 illustrates concave portions 11a provided on a USB (Type-A) memory and engaging portions 51a of a connector housing 50a, according to the present embodiment. In the case of USB

(Type-A), the connection preventing member 1 may be provided with two rectangular-shaped concave portions 11a as the lock units 11, as illustrated in FIG. 2.

The handle 20 is connected to the insertion portion 10 via the connecting portions 21, as illustrated in FIGS. 1A, 1B and 1C.

The connecting portions 21 are formed to be thinner than the insertion portion 10 and the body of the handle 20. The connecting portions 21 are thinner than the insertion portion 10 and the body of the handle 20. The connecting portions 21 may be made of a material different from a material used for the insertion portion 10 such that the connecting portions 21 may be easily broken.

The handle 20 can be separated from the insertion portion 10 after the insertion portion 10 is inserted into the connector housing 50 and then the handle 20 is folded at the connecting portions 21.

More specifically, the handle 20 and the insertion portion 10 are connected via the connecting portions 21 that are made thin in a localized manner, and the strength of the connection preventing member 1 is intentionally weakened at the connecting portions 21. Therefore, bending the connecting portions 21 after inserting the insertion portion 10 causes stress concentration to occur at the base of the insertion portion 10. Thus, the connecting portions 21 can easily be broken.

The handle 20 is preferably provided with a grip 22 on a plate-shaped portion parallel to the insertion portion 10, as illustrated in FIG. 1C. The grip 22 may be provided so as to be easily held from one side so that a side of the insertion portion 10 to be inserted can be easily recognized. In addition, preferably the grip 22 has a shape that can be easily held when the handle 20 is bent at the positions of the connecting portions 21 to separate the insertion portion 10.

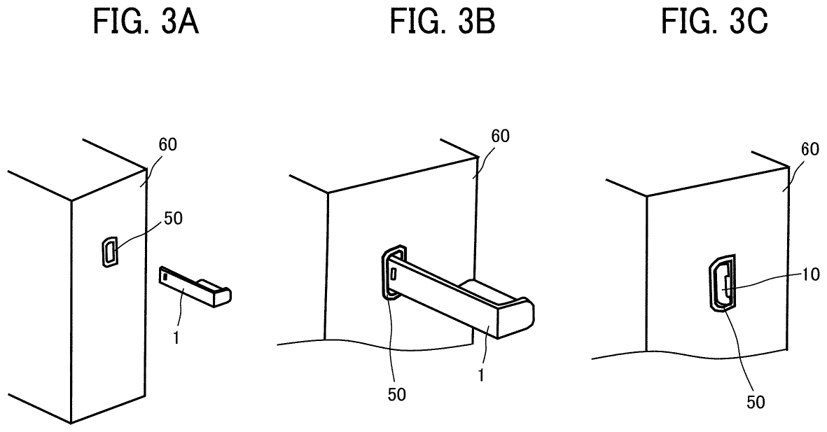

FIGS. 3A, 3B, and 3C are schematic diagrams each illustrating a procedure for attaching the connection preventing member 1 to an electronic apparatus 60 having the connector housing 50, according to the present embodiment. FIG. 3A illustrates a state before the connection preventing member 1 is inserted into the connector housing 50, according to the present embodiment. FIG. 3B illustrates a state in which the connection preventing member 1 is inserted into the connector housing 50, according to the present embodiment. FIG. 3C illustrates a state in which the handle 20 is separated from the insertion portion 10, according to the present embodiment.

Next, the state in which the connection preventing member 1 is inserted into the connector housing 50 is described in detail.

FIGS. 4A and 4B are diagrams each illustrating the insertion portion 10 and the handle 20 before the insertion portion 10 inserted into the connector housing 50 and the handle 20 are separated from each other, according to the present embodiment. FIG. 4A is an external perspective view of the connection preventing member 1 before the insertion portion 10 inserted into the connector housing 50 and the handle 20 are separated from each other, according to the present embodiment. FIG. 4B is a schematic perspective view of a cross section of the connection preventing member 1 along a dotted line IV-IV as illustrated in FIG. 4A.

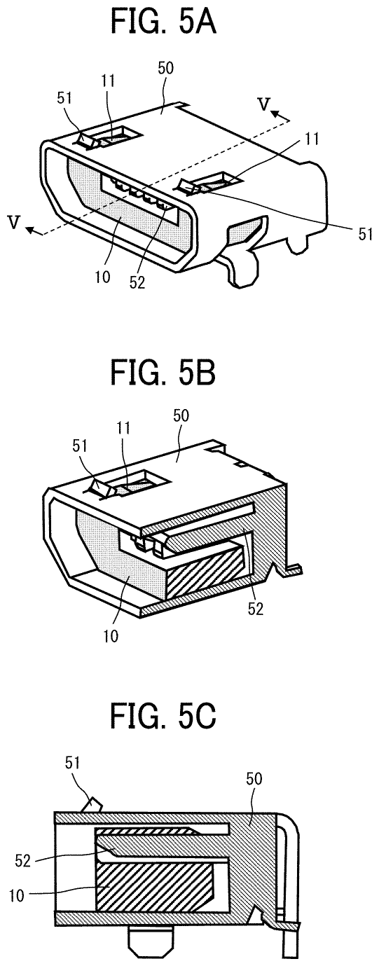

FIGS. 5A, 5B, and 5C are diagrams each illustrating the insertion portion 10 inserted into the connector housing 50 from which the handle 20 is separated, according to the present embodiment. FIG. 5A is an external perspective view of the connector housing 50 into which the insertion portion 10 is inserted, according to the present embodiment. FIG. 5B is a perspective a cross sectional view of the connector housing 50 into which the insertion portion 10 is inserted, along a dotted line V-V as illustrated in FIG. 5A. FIG. 5C is a cross sectional view of the connector housing 50 into which the insertion portion 10 is inserted, along the dotted line V-V as illustrated in FIG. 5A.

FIGS. 4A, 4B, 4C, 5A, and 5B are diagrams each illustrating a state in which the insertion portion 10 is inserted into the connector housing 50 adapted for the micro USB (Type-B), according to the present embodiment. In FIGS. 4B, 5A, and 5B, the outer peripheral surface of the insertion portion 10 is colored in gray on an as-needed basis.

The insertion portion 10 includes protrusions as the lock units 11 on an upper surface of the insertion portion 10. The protrusions that serve as the lock units 11 are provided at the positions where the lock units 11 engage with engaging portions 51 of the connector housing 50. Accordingly, when the lock units 11 are engaged with the engaging portions 51 and the insertion portion 10 is accommodated in the connector housing 50, the insertion portion 10 is prevented from coming off.

Further, in the connector housing 50, the engaging portions 51 are provided at positions closer to an opening of the connector housing 50 than a terminal portion (internal terminal) 52. In this way, when the insertion portion 10 is accommodated in the connector housing 50, the insertion portion 10 can reliably cover the terminal portion 52. Alternatively, the positions of the lock units 11 provided in the insertion portion 10 may be such that the insertion portion 10 covers the entire terminal portion 52 when the lock units 11 and the engaging portions 51 are engaged with each other.

When the insertion portion 10 is separated from the handle 20, the shape of the insertion portion 10 remains only in the connector housing 50, so that the connection preventing member 1 is formed into a shape having no grip for extraction.

Further, in the connector housing 50, the position of the insertion portion 10 remains in a position behind the terminal portion 52. Thus, a portion of the insertion portion 10 caught by a tool such as a knob is eliminated and the insertion portion 10 is prevented from being taken out. For example, a minus driver (knob) cannot be inserted into a portion of the micro USB (Type-B) connector that is not covered by the terminal portion 52 to forcibly pull out the insertion portion 10. Preferably, the insertion portion 10 does not have a shape that catches the terminal portion 52 while covering the terminal portion 52.

Next, the connecting portions 21 are described. As described above, since the connection preventing member 1 includes the insertion portion 10 connected with the handle 20, it is necessary to cut the handle 20 at the connecting portions 21. Therefore, the connection preventing member 1 including the connecting portions 21 has a locally weak structure.

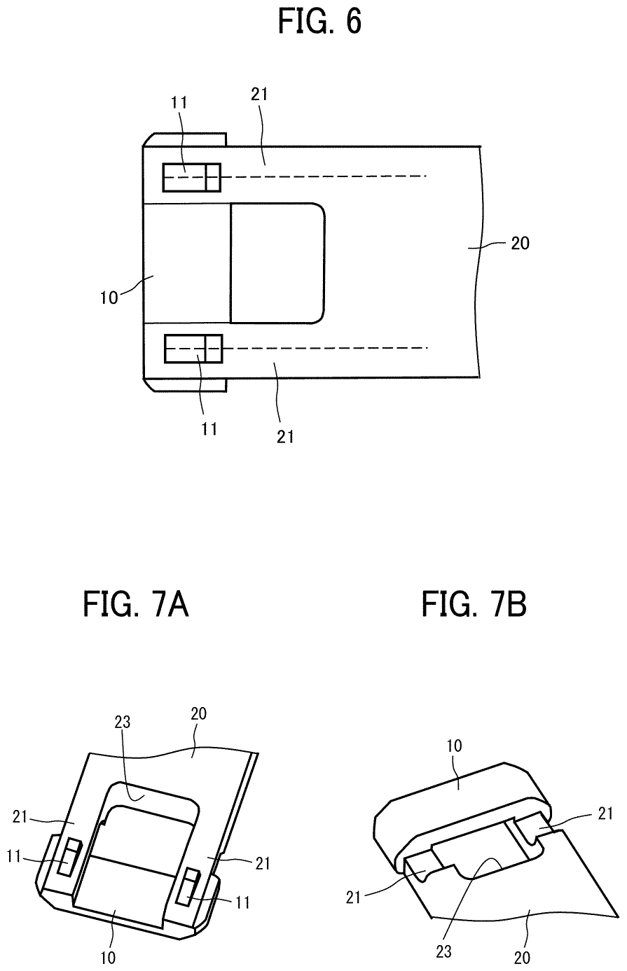

FIG. 6 is a schematic diagram illustrating the relative positions of the insertion portion 10 and the connecting portions 21, according to the present embodiment.

When the insertion portion 10 is viewed from above, each one of the connecting portions 21 is preferably located next to one of the lock units 11 having, for example, a protrusion, a claw, a recess in an insertion direction of the insertion portion 10, as indicated by the broken lines in FIG. 6. Providing the connecting portions 21 at rear positions of the lock units 11 along the direction in which the insertion portion 10 is inserted enables to easily transmit the force at the time of insertion to the insertion portion 10 and to restrain the occurrence of inclination of the insertion portion 10, and the like. Thus, the insertion portion 10 can be prevented from being half-pressed.

Further, two or more of the connecting portions 21 are preferably provided. This is because, in one case, there is a possibility that the connecting portions 21 are inclined and bent. In another case, insertion failure occurs due to inclination of the connecting portions 21 or the like and these cases need to be avoided.

When two or more connecting portions 21 are provided, preferably a gap (space) between adjacent connecting portions 21 is provided. FIGS. 7A and 7B are diagrams each illustrating a gap provided between a pair of the connecting portions 21, according to the present embodiment.

In this way, the connecting portions 21 can be easily folded. FIGS. 7A and 7B are schematic perspective views of the connection preventing member 1. FIG. 7A is a top perspective view of the connection preventing member 1 according to the present embodiment, and FIG. 7B is a bottom perspective view of the connection preventing member 1 according to the present embodiment. The connection preventing member 1 includes a gap 23 between two of the connection portions 21.

Further, as illustrated in FIGS. 7A and 7B, in the connection preventing member 1 according to the present embodiment, a portion that avoids the terminal of the micro USB (Type-B) connector and the gap 23 are continuously formed as a result of processing.

Next, another embodiment of the present disclosure is described in which the connection preventing member 1 according to the above embodiment of the present disclosure is used for an I/O port of a connector housing 79 of an image forming apparatus 70.

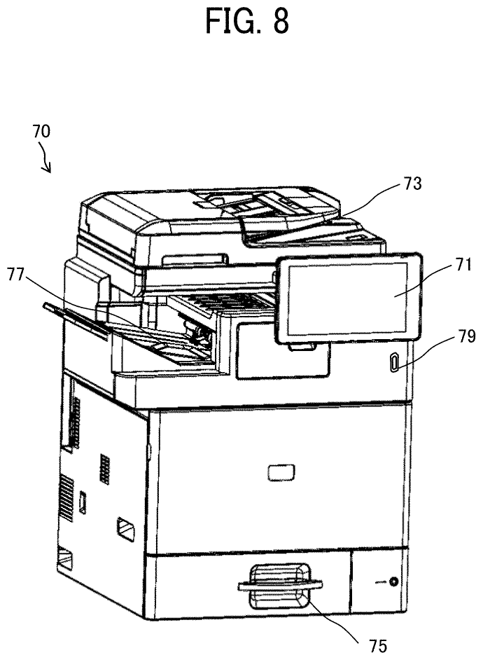

FIG. 8 is a schematic diagram illustrating an external appearance of the image forming apparatus 70, according to the present embodiment. The image forming apparatus 70 includes an operation panel 71, an auto document feeder (ADF) 73 that feeds and conveys documents, a recording medium supply tray 75 that stores a recording medium in a stackable manner before an image is recorded, and a recording medium ejection tray 77 that ejects a recording medium on which an image has been recorded. FIG. 8 illustrates an embodiment in which the connector housing 79 is provided on a side face of the image forming apparatus 70.

Similar to the electronic apparatus 60 described as above with reference to FIG. 3, the image forming apparatus 70 according to the present embodiment can employ the connection preventing member 1 according to the above embodiment of the present disclosure. More specifically, the connection preventing member 1 is inserted into the connector housing 79, and the handle 20 is detached. As a result, the insertion portion 10 can be inserted into the connector housing 79.

Note that the connection preventing member 1 according to the above embodiment of the present disclosure can be applied to any desired image forming apparatus with a connector housing, in addition to the image forming apparatus 70 as illustrated in FIG. 8.

As described above, in the connection preventing member 1 of the present embodiment, the insertion portion 10 enters into the I/O port of the connector housing 79. Thus, a connector cannot be inserted into the I/O port of the connector housing 79. Such a configuration allows provision of a member that can be manufactured at low cost and prevents mischief such as connecting a connector to the I/O port without permission, illegal extraction of internal information or supplying high voltage current to the connector.

Further, since the insertion portion 10 is formed in such a shape that the insertion portion 10 is located in a position deeper than the internal terminal portion and covers the entire terminal portion of the I/O port and is not caught. Thus, the insertion portion 10 cannot be pulled out using a tool or the like.

In addition, in the present embodiment, the handle 20 is provided. Such a configuration prevents the insertion portion 10 from being inserted in a wrong direction or the insertion portion 10 from being insufficiently inserted.

Further, according to the present embodiment, for example, the following disadvantages can be solved.

In a conventional operation panel, an operation unit is provided with a USB port for sending a file to a multifunction peripheral (MFP) and printing the file or storing scanned data in a USB memory.

However, there is also a demand for preventing unauthorized access (extraction of data or the like) and mischief through the USB port. In order to cope with such a demand, a USB connector is removed from a substrate, and a dedicated cover for closing the opening of a housing is prepared. Accordingly, such a configuration may require increased cost.

In addition, some USB devices may destroy an apparatus by supplying a high-voltage current through an internal substrate of the USB device. Thus, there are cases in which the apparatus is destroyed by a malicious user even if the use of the USBs is restricted by software.

In the present embodiment, unauthorized access and mischievous use of the I/O port can be prevented at a low cost and easily without preparing a dedicated substrate, cover, or software.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present disclosure.

What is claimed is:

1. A connection preventing member comprising:
an insertion portion configured to mechanically engage with a connector housing having an opening connected to an input and output (I/O) port of an electric apparatus, the insertion portion including a lock unit configured to engage with an engagement portion of the connector housing; and
a handle connected to the insertion portion via a connecting portion, the handle being configured to be foldable at the connecting portion and separable from the insertion portion after the insertion portion is inserted into the connector housing,
the lock unit being at a position at which the insertion portion covers a terminal portion of the connector housing when the lock unit engages with the engagement portion and the handle is separated from the insertion portion.

2. The connection preventing member according to claim 1,
wherein the I/O port of the electric apparatus is a micro universal serial bus (USB) port.

3. The connection preventing member according to claim 1, further comprising:
a plurality of engagement portions including the engagement portion,
a plurality of lock units including the lock unit, each one of the plurality of lock units being configured to engage with one of the plurality of engagement portions; and
a plurality of connecting portions including the connecting portion, each one of the plurality of connecting portions being disposed next to one of the plurality of lock units in an insertion direction of the insertion portion to the connection housing.

4. The connection preventing member according to claim 3,
wherein the plurality of connecting portions are disposed parallel to each other with a space between each pair of the plurality of connecting portions.

5. An image forming apparatus comprising:
a connector housing; and
the insertion portion of the connection preventing member according to claim 1, the insertion portion being inserted into the connector housing.

6. The connection preventing member according to claim 2, further comprising:
a plurality of engagement portions including the engagement portion;
a plurality of lock units including the lock unit, each one of the plurality of lock units being configured to engage with one of the plurality of engagement portions; and
a plurality of connecting portions including the connecting portion, each one of the plurality of connecting portions being disposed next to one of the plurality of lock units in an insertion direction of the insertion portion to the connector housing.

7. The connection preventing member according to claim 6,
wherein the plurality of connecting portions are disposed parallel to each other with a space between each pair of the plurality of connecting portions.

8. An image forming apparatus comprising:
a connector housing; and
the insertion portion of the connection preventing member according to claim 7, the insertion portion being inserted into the connector housing.
